(19) United States
(12) Patent Application Publication
(10) Pub. No.: US 2020/0354485 A1
(43) Pub. Date: Nov. 12, 2020

(54) Olefin polymerization Ziegler-Natta catalyst components and process for the production of olefin polymers therewith

(71) Applicant: Formosa Plastics Corporation, USA, Livingston, NJ (US)

(72) Inventors: Lei Zhang, Port Lavaca, TX (US); Gapgoung Kong, Sugarland, TX (US); Chih-Jian Chen, Port Lavaca, TX (US); Guangxue Xu, Port Lavaca, TX (US)

(21) Appl. No.: 16/405,601

(22) Filed: May 7, 2019

(51) Int. Cl. C08F 4/656; C08F 10/06; C08F 4/649

(52) U.S. Cl. CPC C08F 4/6567; C08F 10/06; C08F 4/022; C08F 4/6565; C08F 4/6494

(57) ABSTRACT

The present invention relates to a solid Ziegler-Natta catalyst component for olefin polymerization containing an organosilicon element in combination with one or more internal electron donors. The catalyst components, according to the present invention, are able to produce polypropylene polymers with higher stereo-regularity. The present invention also provides a phthalate-free catalyst system capable of producing polypropylene with an isotacticity that is equal to or higher than catalyst systems containing phthalate derivatives.

### BACKGROUND

### 1. Field of the Invention

This invention relates (1) to Ziegler-Natta catalyst components for olefin polymerization employing specific forms of organosilicon compounds as an element of the solid catalyst composition in conjunction with one or more internal donor compounds, (2) to methods of making such polymerization catalyst systems, and (3) to polymerization processes for producing polyolefins, particularly polypropylene, that exhibit substantially higher stereo-regularity and activity.

### 2. Description of the Related Art

Ziegler-Natta catalyst systems for polyolefin polymerization are well known in the art. Commonly, these systems are composed of a solid Ziegler-Natta catalyst component and a co-catalyst component, usually an organoaluminum compound, and/or an external electron donor to be used in conjunction. The Ziegler-Natta catalyst components have included magnesium, halide, titanium and internal electron do nor compounds which have been widely employed to increase the activity and stereo-specificity of polymerization catalyst system.

Common internal electron donor compounds, which are incorporated in the solid Ziegler-Natta catalyst component during preparation of such component, are known in the art and include organic acid esters, ethers, ketones, amines, alcohols, heterocyclic organic compounds, phenols, and phosphines. It is well known in the art that polymerization activity, as well as stereoregularity, molecular weight, and molecular weight distribution of the resulting polymer depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 5,948,872; 6,048,818;6,121,483; 6,281,301; 6,294,497; 6,313,238; 6,395,670; 6,436,864; 6,605,562; 6,716,939; 6,770,586; 6,818,583; 6,825,309; 7,022,640; 7,049,377; 7,202,314; 7,208,435; 7,223,712; 7,351,778; 7,371,802; 7,491,781; 7,544,748; 7,674,741; 7,674,943; 7,888,437; 7,888,438; 7,935,766;7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,288,606; 8,318,626; 8,383,540; 8,536,290; 8,569,195; 8,575,283; 8,604,146; 8,633,126; 8,692,927; 8,664,142; 8,680,222; 8,716,514; and 8,742,040, which are incorporated by reference herein.

In the utilization of Ziegler-Natta type catalysts for polymerizations involving propylene or other olefins for which isotacticity is a possibility, it may be desirable to utilize an external electron donor, and acceptable external electron donors include organic compounds containing O, Si, N, S, and/or P. Such compounds include organic acids, organic acid esters, organic acid anhydrides, ethers, ketones, alcohols, aldehydes, silanes, amides, urea, amines, amine oxides, thiols, various phosphorus acid esters and amides, etc. Preferred external electron donors are organosilicon compounds containing Si—O—C and/or Si—N—C bonds, having silicon as the central atom. Such compounds are described in U.S. Pat. Nos. 4,472,524; 4,473,660; 4,560,671; 4,581,342; 4,657,882; 5,106,807; 5,407,883; 5,684,173; 6,228,961; 6,362,124; 6,552,136; 6,689,849; 7,009,015; 7,244,794; 7,276,463; 7,619,049; 7,790,819; 8,247,504; 8,648,001; and 8,614,162, which are incorporated by reference herein. U.S. Pat. No. 6,271,310 listed urea as a potential external donor that may be used for propylene polymerization.

Most commercial propylene polymerization catalysts currently employ alkyl phthalate esters as an internal electron donor. But still there is a need to further improve stereo-regularity of catalyst components employing alkyl phthalate esters as an internal donor for the application of polypropylene polymer to impact copolymer area. Moreover, certain environmental issues have been recently raised concerning the continued use of phthalate derivatives in human contact applications. As a result, the employment of a phthalate-free propylene polymerization catalyst or a catalyst system that employs a reduced amount of phthalate is now necessary for the production of polypropylene to remedy these issues.

U.S. Pat. No. 6,323,150 describes the use of a propylene polymerization catalyst which contains a reduced amount of phthalate as an internal electron donor. However, the resultant polypropylene product was found to exhibit low isotacticity and productivity. This reference further taught a polymerization catalyst consisting of a polyether compound combined with the phthalate derivative as internal electron donors. The resultant polypropylene product exhibits lower isotacticity than that of a catalyst containing only the phthalate derivative.

U.S. Pat. No. 7,491,781 teaches the use of an internal electron donor in a propylene polymerization catalyst component which does not contain a phthalate derivative. However the resultant propylene polymerization catalyst produced polypropylene with lower isotacticity than that of a catalyst containing a phthalate derivative.

U.S. Pat. No. 7,208,435 teaches the use of disiloxane and polysiloxane in a propylene polymerization catalyst component which uses a malonate derivative as internal donor. U.S. Pat. No. 9,045,572 describes a method for preparing a solid catalyst for propylene polymerization by using tetraalkoxysilane compounds and bicycloalkanedicarboxylate or bicycloalkenedicarboxylate as an internal electron donor. However, the stereo-regularity of such phthalate-free catalysts is not sufficient to produce polypropylene with high isotacticity.

U.S. Pat. Publ. No. 2014/0163185 teaches the use of Si-H functional group containing chainlike polysiloxanes in a polypropylene catalyst component to improve catalyst activity and polymer bulk density. However, the stereo-regularity of such polysiloxane-treated catalysts was not improved.

U.S. Pat. No. 7,276,463 teaches the use of compound containing a C(═O)N bond, such as amide or urea, as an external donor in the polymerization process, in combination with a silicon compound and an organoaluminum compound that enables the production of olefin polymer with improved stereo-regularity. However urea was never employed as an element of a solid catalyst composition in the catalyst preparation process, and never enabled production of phthalate-free catalyst system with stereo-regularity that is equal to or better than phthalate catalyst systems.

As such, there is still a need of development for a catalyst system that can produce polypropylene with further higher isotacticity, hydrogen response, and activity. Even more desirable is the development of phthalate free catalyst system producing polypropylene with even higher isotacticity.

### SUMMARY OF THE INVENTION

It is therefore an object of present invention to provide a method of preparing Ziegler-Natta catalyst components for producing polypropylene with enhanced isotacticity and activity, where the solid catalyst components comprise magnesium, titanium, halide, one or more internal electron donors, and at least one Si—N-bond-containing organosilicon compound selected from the compound represented by Formula I:

RₘSi(NR¹R²)ₙ(XR³)₍₄₋ₘ₋ₙ₎ [Formula I]

wherein R, R¹, R² and R³, which may be identical or different, are independently hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hydrocarbon group of 1 to 20 carbon atoms containing one or more hetero-atoms selected from the group consisting of N, O, S, Si, B, P, and halogen atoms, wherein two or more of R, R¹, R² and R³ may be linked to form one or more saturated or unsaturated monocyclic or polycyclic rings; wherein X is O or S, wherein m is 0≤m≤3, n is 1≤n≤4, and 1≤(m+n)<4, wherein when m >1, R′s may be identical or different, wherein when n>1, R¹'s and R²'s may be identical or different, wherein when (4−m−n)>1, (XR³)'s may be identical or different.

### DESCRIPTION OF PREFERRED EMBODIMENTS

In accordance with certain embodiments of the present invention, a class of Si—N—bond-containing organosilicon compounds employed as an element of solid Ziegler-Natta catalyst components in conjunction with one or more internal donors, for the production of polyolefins, particularly polypropylene, are disclosed. The organosilicon compounds of the present invention may be used in combination with one or more internal electron donors that are typically employed in Ziegler-Natta polypropylene catalyst systems such as 1,3-diethers, malonates, succinates, phthalic acid esters, esters of aliphatic or aromatic diols, or their derivatives.

According to certain aspects of the present invention, the Si—N-bond-containing organosilicon compounds that may be employed as an element of a solid catalyst composition are represented by Formula I:

RₘSi(NR¹R²)ₙ(XR³)₍₄₋ₘ₋ₙ₎ [Formula I]

wherein R, R¹, R² and R³, which may be identical or different, are independently hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hydrocarbon group of 1 to 20 carbon atoms containing one or more hetero-atoms selected from the group consisting of N, O, S, Si, B, P, and halogen atoms, wherein two or more of R, R¹, R² and R³ may be linked to form one or more saturated or unsaturated monocyclic or polycyclic rings; wherein X is O or S, wherein m is 0≤m≤3, n is 1≤n≤4, and 1≤(m+n)≤4, wherein when m>1, R's may be identical or different, wherein when n>1, R¹'s and R²'s may be identical or different, wherein when (4−m−n)>1, (XR³)'s may be identical or different.

Preferred embodiments of the organosilicon compounds of Formula I include, but not limited to non-cyclic organosilicon compounds, such as: N,N-diethyl-1, 1-dimethoxy-1-propylsilanamine, N,N-diethyl-1, 1-diethoxy-1-propylsilanamine, N,N-diethyl-1, 1-dimethoxy-1 -cyclopentylsilanamine, N-(dimethoxypropyisilyl)-N-ethyl-benzenamine, N-(dimethoxypropyisily 1)-N-ethyl cyclohexanamine, diethylaminotrimethoxysilane, diethylaminotriethoxysilane, bis(diethylamino)dimethoxysilane, bis(diethylamino)diethoxysilane, di(piperidinyl) dimethoxysilane, di(pipericlinyl)diethoxysilane, di(pyrrolidinyl)dimethoxysilane, di(pyrrolidinyl) diethoxysilane, 2,2′-(dimethoxysilylene)bis(decahydroisoquinoline), or their derivatives.

Other suitable amide compounds of Formula I include, but are not limited to, cyclic organosilicon compounds:

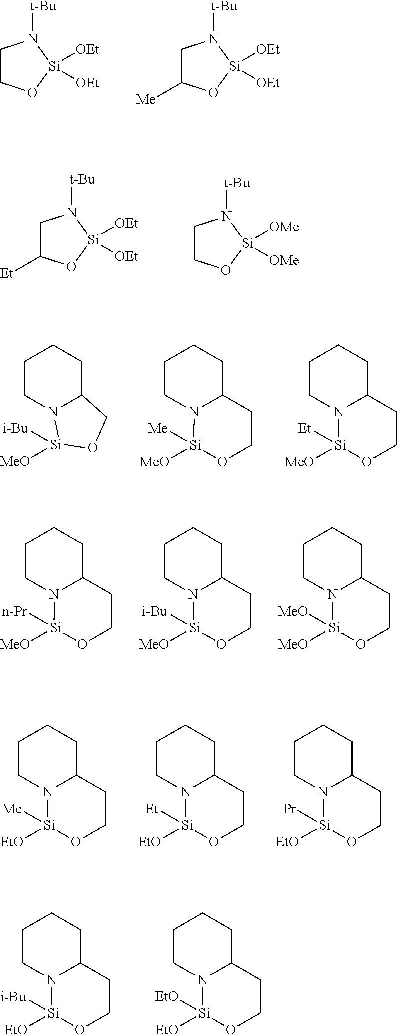

Typical, and acceptable, Ziegler-Natta type catalyst systems that may be used in accordance with the present invention comprise (a) a solid Ziegler-Natta type catalyst component, (b) a co-catalyst component, and optionally (c) one or more external electron donors. Preferred solid Ziegler-Natta type catalyst components (a) include solid catalyst components comprising a titanium compound having at least a Ti-halogen bond and a Si—N-bond-containing organosilicon compound of Formula I in combination with an internal electron donor compound supported on an anhydrous magnesium-dihalide support.

At least one of Si—N-bond-containing organo silicon compounds of Formula I may be used for the preparation of solid Ziegler-Natta type catalyst component (a). The organosilicon compound of the present invention is immobilized on an anhydrous magnesium-dihalide support to change the chemical composition of the solid Ziegler-Natta type catalyst component (a) and to optimize the olefin-polymerization-catalyzation properties of the resultant solid catalyst component (a). The role played by the organosilicon compound of the present invention is more like a secondary internal donor and different from that in the prior art, e.g. U.S. Pat. Nos. 5,202,958, 7,619,049, 7,790,819, U.S. Pat. Publ. No. 2013/284602 in which Si—N-bond-containing organosilicon compounds are used as external donors in the polymerization and/or pre-polymerization of olefins.

Acceptable internal electron donor compounds for the preparation of solid Ziegler-Natta type catalyst component (a) are not generally limited and include, but are not limited to, one or more internal electron donors that are typically employed in Ziegler-Natta polypropylene catalyst system, such as 1,3-diethers, malonates, succinates, phthalic acid esters, esters of aliphatic or aromatic diols, or their derivatives.

Examples of phthalic acid esters that may be used in conjunction with Formula I compounds include, but are not limited to: diethylphthalate, di-n-propylphthalate, di-n-butylphthalate, di-n-pentylphthalate, di-i-pentylphthalate, bis(2-ethylhexyl)phthalate, ethylisobutylphthalate, ethyl-n-butylphthalate, di-n-hexylphthalate, di-isobutylphthalate.

Examples of 1,3-diethers that may be used in conjunction with Formula I compounds include, but are not limited to: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 1,1-bis(methoxymethyl)-7-(3,3,3-trifluoropropyl)indene, 1,1-bis(methoxymethyl)-7-trimethyisilylindene; 1,1-bis(methoxymethyl)-7-trifluoromethylindene, 1,1-bis(methoxymethyl)-4,7-dimethyl-4,5,6,7-tetrahydroindene, 1,1-bis(methoxymethyl)-7-methylindene, 1,1-bis(methoxymethyl)-1H-benz[e]indene, 1,1-bis(methoxymethyl)-1H-2-methylbenz[e]indene, 9,9-bis(methoxymethyl)fluorene, 9,9-bis(methoxymethyl)-2,3,6,7-tetramethylfluorene, 9,9-bis(methoxymethyl)-2,3,4,5,6,7-hexafluorofluorene, 9,9-bis(methoxymethyl)-2,3-benzofluorene, 9,9-bis(methoxymethyl)-2,3,6,7-dibenzofluorene, 9,9-bis(methoxymethyl)-2,7-diisopropylfluorene, 9,9-bis(methoxymethyl)-1,8-dichlorofluorene, 9,9-bis(methoxymethyl)-2,7-dicyclopentylfluorene, 9,9-bis(methoxymethyl)-1,8-difluorofluorene, 9,9-bis(methoxymethyl)-1,2,3,4-tetrahydrofluorene, 9,9-bis(methoxymethyl)-1,2,3,4,5,6,7,8-octahydrofluorene, 9,9-bis(methoxymethyl)-4-tert-butylfluorene.

Examples of malonates that may be used in conjunction with Formula I compounds include, but are not limited to: diethyl2-isopropylmalonate, diethyl2-phenylmalonate, dineopentyl 2-isopropylmalonate, diisobutyl 2-isopropylmalonate, di-n-butyl 2-isopropylmalonate, diethyl 2-dodecylmalonate, diethyl 2-t-butylmalonate, diethyl 2-(2-pentyl)malonate, diethyl 2-cyclohexylmalonate, dineopentyl 2-t-butylmalonate, dineopentyl 2-isobutylmalonate, diethyl 2-cyclohexylmethylmalonate, dimethyl 2-cyclohexylmethylmalonate, diethyl 2,2-dibenzylmalonate, diethyl 2-isobutyl-2-cyclohexylmalonate, dimethyl 2-n-butyl-2-isobutylmalonate, diethyl 2-n-butyl-2-isobutylmalonate, diethyl 2-isopropyl-2-n-butylmalonate, diethyl 2-methyl-2-isopropylmalonate, diethyl 2-isopropyl-2-isobutylmalonate, diethyl 2-methyl-2-isobutylmalonate, diethyl 2-isobutyl-2-benzylmalonate, diethyldiisobutylmalonate.

Examples of succinates that may be used in conjunction with Formula I compounds include, but are not limited to: diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2.3-bis(cyclohexylinethyl)succinate, diethyl 2,3-diisobutylsuccinate, diethyl 2,3-dineopentylsuccinate, diethyl 2,3-dicyclopentylsuccinate, diethyl 2,3 -dicyclohexylsuccinate.

Examples of esters of aliphatic or aromatic diols that may be used in conjunction with Formula I compounds include, but are not limited to: 1,3-propylene-glycol dibenzoate, 2-methyl-1,3-propylene-glycol dibenzoate, 2-ethyl-1,3-propylene-glycol dibenzoate, 2-propyl -1,3-propylene-glycol dibenzoate, 2-butyl-1,3-propylene-glycol dibenzoate, 2,2-dimethyl-1,3-propylene-glycol dibenzoate, (R)-1-phenyl-1,3-propylene-glycol dibenzoate, (S)-1-phenyl-1,3-propylene-glycol dibenzoate, 1,3-diphenyl-1,3-propylene-glycol dibenzoate, 2-methyl-1,3-diphenyl-1,3-propylene-glycol dibenzoate, 1,3-diphenyl-1,3-propylene-glycol dipropionate, 2-methyl-1,3-diphenyl-1,3-propylene-glycol dipropionate, 2,4-pentanediol dibenzoate, 3-methyl-2,4-pentanediol dibenzoate, 3-ethyl-2,4-pentanediol dibenzoate, 3-propyl-2,4-pentanedioldibenzoate, 3-butyl-2,4-pentanediol dibenzoate, 3,3-dimethyl-2,4-pentanediol dibenzoate, (2S,4S)-(+)-2,4-pentanediol dibenzoate, (2R,4R)-(+)-2,4-pentanediol dibenzoate, 2,4-pentanediol di(p-chlorobenzoate), 2,4-pentanediol di(m-chlorobenzoate), 2,4-pentanediol di(p-bromobenzoate), 2,4-pentanediol di(o-bromobenzoate), 2,4-pentanediol di(p-methylbenzoate) 2,4-pentanediol di(p-tert-butylbenzoate), 2,4-pentanediol di(p-butylbenzoate), 2,4-pentanediol dicinnamate, 2-methyl-1,3-pentanediol dibenzoate, 2-methyl-1,3-pentanediol di(p-chlorobenzoate), 2-methyl-1,3-pentanediol di(p-methylbenzoate), 2-butyl-1,3-pentanediol di(p-methylbenzoate), 2-methyl-1,3-pentanediol di(p-tert-butylbenzoate)

Acceptable anhydrous magnesium dihalides forming the support of the solid Ziegler-Natta type catalyst component (a) are the magnesium dihalides in active form that are well known in the art. Such magnesium dihalides may be preactivated, may be activated in situ during the titanation, may be formed in-situ from a magnesium compound, which is capable of forming magnesium dihalide when treated with a suitable halogen-containing transition metal compound, and then activated. Such magnesium dihalides may also be formed as a layer on the surface of other inorganic supports. Preferred magnesium dihalides are magnesium dichloride and magnesium dibromide. The water content of the dihalides is generally less than 1% by weight.

The solid Ziegler-Natta type catalyst component (a) may be made by various methods. One such method consists of co-grinding the magnesium dihalide and the internal electron donor compound until the product shows a surface area higher than 20 m²/g and thereafter reacting the ground product with the Ti compound. Other methods of preparing solid Ziegler-Natta type catalyst component (a) are disclosed in U.S. Pat. Nos. 4,220,554; 4,294,721; 4,315,835; 4,330,649; 4,439,540; 4,816,433; and 4,978,648. These methods are incorporated herein by reference.

In a typical modified solid Ziegler-Natta type catalyst component (a), the molar ratio between the magnesium dihalide and the halogenated titanium compound is between 1 and 500, the molar ratio between said halogenated titanium compound and the internal electron donor is between 0.1 and 50, and the molar ratio between said internal electron donor and Si-N-bond-containing organosilicon compound is between 0.1 and 100.

Preferred co-catalyst component (b) includes aluminum alkyl compounds, which can be represented by the Formula II;

RₙAlQ₃₋ₙ [Formula II]

wherein R represents an alkyl group having 1 to 6 carbon atoms, Q represents a hydrogen or a halogen atom, and n represents a real number that satisfies 0<n≤3. Acceptable aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component (b) includes compounds containing two or more aluminum atoms linked to each other through hetero-atoms, such as:

(C₂H₅)₂Al—O—Al(C₂H₅)₂

(C₂H₅)₂Al—N(C₆H₅)—Al(C₂H₅)₂; and

(C₂H₅)₂Al—O—SO₂—O—Al(C₂H₅)₂.

Acceptable external electron donor component (c) is organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. Preferred component (c) is organosilicon compounds containing Si—O—C and/or Si—N—C bonds. Specific examples of such organosilicon compounds are, without limitation, trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3 -tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro [4.4]nonane, and bis(perhydroisoquinolino)dimethoxysilane. Mixtures of organic electron donors may also be used.

The olefin polymerization processes that may be used in accordance with the present invention are not generally limited. For example, the catalyst components (a), (b) and (c), when employed, may be added to the polymerization reactor simultaneously or sequentially. It is preferred to mix components (b) and (c) first and then contact the resultant mixture with component (a) prior to the polymerization.

The olefin monomer may be added prior to, with, or after the addition of the Ziegler-Natta type catalyst system to the polymerization reactor. It is preferred to add the olefin monomer after the addition of the Ziegler-Natta type catalyst system. The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta type catalyst systems of the present invention may be pre-contacted with small quantities of olefin monomer, well known in the art as prepolymerization, in a hydrocarbon solvent at a temperature of 60 ° C. or lower for a time sufficient to produce a quantity of polymer from 0.5 to 3 times the weight of the catalyst. If such a prepolymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homopolymerization and copolymerization of alpha olefins. Suitable a-olefins that may be used in a polymerization process in accordance with the present invention include olefins of the general formula CH₂═CHR, where R is H or C₁₋₁₀straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The catalyst activity values (AC) are based upon grams of polymer produced per gram of solid catalyst component used.

The following analytical methods are used to characterize the polymer.

Heptane Insolubles (% HI): The weight percent (wt %) of residuals of polypropylene sample after extracted with boiling heptane for 8 hours.

Melt Flow rate (MFR): ASTM D-1238, determined at 230° C. under the load of 2.16 kg.

Magnesium ethoxide (98%), anhydrous toluene (99.8%), TiCl₄ (99.9%), anhydrous n-heptane (99%), diisobutyl phthalate (99%) and triethylaluminum (93%) were all purchased from Sigma-Aldrich Co. of Milwaukee, Wis., USA.

Diisopropyldimethoxysilane (P-donor) was purchased from Gelest, Inc. of Morrisville, Pa., USA.

Unless otherwise indicated, all reactions were conducted under an inert atmosphere.

### Example 1

### (A) The Preparation of a Solid Catalyst Component

To a three-neck 250 ml flask equipped with a mechanic stirrer, which is thoroughly purged with anhydrous nitrogen, 9.2 g (80 mmol) of magnesium ethoxide, and 80 ml of anhydrous toluene was introduced to form a suspension. 20 ml of TiCl₄ was added. The temperature of the mixture was gradually raised to 90° C., and 10.0 mmol of diisobutyl phthalate and 1.8 mmol of diethylaminotriethoxysilane were charged. The temperature of the mixture was increased to 110° C., and maintained for 2 hours with stirring. The resulting solid was precipitated and supernatant liquid was decanted. The solid was washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was precipitated and supernatant liquid was decanted and residual solid was washed with heptane 7 times at 70° C. The final catalyst was collected and dried under vacuum to obtain a solid catalyst component (A1).

(B) Propylene Slurry Polymerization

Propylene polymerization was conducted in a bench scale 2-liter reactor per the following procedure. The reactor was first preheated to at least 100° C. with a nitrogen purge to remove residual moisture and oxygen. The reactor was thereafter cooled to 50° C. Under nitrogen, 1 liter dry heptane was introduced into the reactor. When reactor temperature was about 50° C., 4.3 ml of triethylaluminum (0.58 M, in hexanes), 0.4 ml of Diisopropyldimethoxysilane (P-donor) (0.5 M in heptane), and then 30 mg of the solid catalyst component (A1) prepared above were added to the reactor. The temperature of the reactor was heated to 50° C. and 8 psi or 150 psi hydrogen in a 150 ml vessel was flushed into the reactor with propylene.

The reactor temperature was then raised to 70 ° C. The total reactor pressure was raised to and controlled at 90 psig by continually introducing propylene into the reactor and the polymerization was allowed to proceed for 1 hour. After polymerization, the reactor was vented to reduce the pressure to 0 psig and the reactor temperature was cooled to 50° C.

The reactor was then opened. 500 ml methanol was added to the reactor and the resulting mixture was stirred for 5 minutes then filtered to obtain the polymer product. The obtained polymer was vacuum dried at 80° C. for 6 hours. The polymer was evaluated for melt flow rate (MFR), and heptane insoluble (% HI). The activity of catalyst (AC) was also measured. The results are summarized in TABLE 1 & 2.

### Example 2

A solid catalyst component (A2) was prepared in the same manner as in Example 1, except that 3.6 mmol of diethylaminotriethoxysilane was used instead of 1.8 mmol of diethylaminotriethoxysilane. Propylene polymerization was carried out in the same manner as described in Example 1, except that solid catalyst component (A2) was charged instead of solid catalyst component (A1). The results are summarized in TABLE 1 & 2.

### Example 3

A solid catalyst component (A3) was prepared in the same manner as in Example 1, except that 3.6 mmol of Hexahydro-1-methoxy-1-(2-methylpropyl)-1H,3H-Pyrido[1,2-c][1,3,2]oxazasiline was used instead of 1.8 mmol of diethylaminotriethoxysilane. Propylene polymerization was carried out in the same manner as described in Example 1, except that solid catalyst component (A3) was charged instead of solid catalyst component (A1). The results are summarized in TABLE 1 & 2.

### Example 4

A solid catalyst component (A4) was prepared in the same manner as in Example 1, except that 3.6 mmol of 2,2′-(Dimethoxysilylene)bis[decahydroisoquinoline] was used instead of 1.8 mmol of diethylaminotriethoxysilane. Propylene polymerization was carried out in the same manner as described in Example 1, except that solid catalyst component (A4) was charged instead of solid catalyst component (A1). The results are summarized in TABLE 1 & 2.

### Comparative Example 1

A solid catalyst component (C1) was prepared in the same manner as in Example 1, except that 1.8 mmol of diethylaminotriethoxysilane was not used. Propylene polymerization was carried out in the same manner as described in Example 1, except that solid catalyst component (C1) was charged instead of solid catalyst component (A1). The results are summarized in TABLE 1 & 2.

### Example 5

### (A) The Preparation of a Solid Catalyst Component

To a three-neck 250 ml flask equipped with a mechanic stirrer, which is thoroughly purged with anhydrous nitrogen, 9.2 g (80 mmol) of magnesium ethoxide, and 80 ml of anhydrous toluene was introduced to form a suspension. 20 ml of TiCl₄ was added. The temperature of the mixture was gradually raised to 90° C., and 10.0 mmol of 9,9-bis(methoxymethyl)fluorene and 3.6 mmol of diethylaminotriethoxysilane were charged. The temperature of the mixture was increased to 110° C., and maintained for 2 hours with stirring. The resulting solid was precipitated and supernatant liquid was decanted. The solid was washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was precipitated and supernatant liquid was decanted and residual solid was washed with heptane 7 times at 70° C. The final catalyst was collected and dried under vacuum to obtain a solid catalyst component (A5).

### (B) Propylene Slurry Polymerization

Propylene polymerization was conducted in a bench scale 2-liter reactor per the following procedure. The reactor was first preheated to at least 100° C. with a nitrogen purge to remove residual moisture and oxygen. The reactor was thereafter cooled to 50° C. Under nitrogen, 1 liter dry heptane was introduced into the reactor. When reactor temperature was about 50° C., 4.3 ml of triethylaluminum (0.58 M, in hexanes), 0.4 ml of Diisopropyldimethoxysilane (P-donor) (0.5 M in heptane), and then 30 mg of the solid catalyst component (A5) prepared above were added to the reactor. The temperature of the reactor was heated to 50° C. and 8 psi or 60 psi hydrogen in a 150 ml vessel was flushed into the reactor with propylene.

The reactor temperature was then raised to 70° C. The total reactor pressure was raised to and controlled at 90 psig by continually introducing propylene into the reactor and the polymerization was allowed to proceed for 1 hour. After polymerization, the reactor was vented to reduce the pressure to 0 psig and the reactor temperature was cooled to 50° C.

The reactor was then opened. 500 ml methanol was added to the reactor and the resulting mixture was stirred for 5 minutes then filtered to obtain the polymer product. The obtained polymer was vacuum dried at 80° C. for 6 hours. The polymer was evaluated for melt flow rate (MFR), and heptane insoluble (% HI). The activity of catalyst (AC) was also measured. The results are summarized in TABLE 1 & 2.

### Example 6

A solid catalyst component (A6) was prepared in the same manner as in Example 5, except that 3.6 mmol of Hexahydro-1-methoxy-1-(2-methylpropyl)-1H,3H-Pyrido[1,2-c][1,3,2]oxazasiline was used instead of diethylaminotriethoxysilane. Propylene polymerization was carried out in the same manner as described in Example 5, except that solid catalyst component (A6) was charged instead of solid catalyst component (A5). The results are summarized in TABLE 1&2.

### Comparative Example 2

### The Preparation of a Solid Catalyst Component (C2)

A solid catalyst component (C2) was prepared in the same manner as in Example 5, except that of 3.6 mmol of diethylaminotriethoxysilane was not added.

(B) Propylene slurry polymerization

Propylene polymerization was carried out in the same manner as described in Example 5, except that solid catalyst component (C2) was charged instead of solid catalyst component (A5). The results are summarized in TABLE 1 & 2.

TABLE 1
Organosilicon compound & internal donor
composition in solid Catalyst Components

| Catalyst | Internal Donor | Organosilicon compound |
|---|---|---|
| components | (mmol) | (mmol) |
| A1 | DiBP* (10.0) | Diethylaminotriethoxysilane (1.8) |
| A2 | DiBP* (10.0) | Diethylaminotriethoxysilane (3.6) |
| A3 | DiBP* (10.0) | Hexahydro-1-methoxy-1-(2- |
| | | methylpropyl)-1H,3H-Pyrido[1,2- |
| | | c][1,3,2]oxazasiline (3.6) |
| A4 | DiBP* (10.0) | 2,2′-(Dimethoxysilylene)bis[deca- |
| | | hydroisoquinoline] (3.6) |
| A5 | 1,3-diether** (10.0) | diethylaminotriethoxysilane (3.6) |
| A6 | 1,3-diether** (10.0) | Hexahydro-1-methoxy-1-(2- |
| | | methylpropyl)-1H,3H-Pyrido[1,2- |
| | | c][1,3,2]oxazasiline (3.6) |
| C1 | DiBP* (10.0) | none |
| C2 | 1,3-diether** (10.0) | none |

*DiBP = Diisobutylphthalate
**1,3-diether = 9,9-bis(methoxymethyl)fluorene

TABLE 2
Polymerization Summary

| | | Ext. Donor | H₂ | MFR | Activity | HI |
|---|---|---|---|---|---|---|
| Example | Catalyst | (mmol) | (psi)* | (g/10 min) | (g/g cat.) | (%) |
| Ex. 1 | A1 | P (0.2) | 8 | 1.2 | 8307 | 99.6 |
| | | | 150 | 215 | 8224 | 97.7 |
| Ex. 2 | A2 | P (0.2) | 8 | 1.5 | 7294 | 99.6 |
| | | | 150 | 240 | 6977 | 98.2 |
| Ex. 3 | A3 | P (0.2) | 8 | 1.8 | 4884 | 99.5 |
| | | | 150 | 202 | 5024 | 98.2 |
| Ex. 4 | A4 | P (0.2) | 8 | 2.9 | 3397 | 99.2 |
| | | | 150 | 282 | 3710 | 97.6 |
| Comp. Ex 1 | C1 | P (0.2) | 8 | 2.0 | 5954 | 99.1 |
| | | | 150 | 216 | 6654 | 97.1 |
| Ex. 5 | A5 | P (0.2) | 8 | 7.7 | 6237 | 99.3 |
| | | | 60 | 225 | 5207 | 97.9 |
| Ex. 6 | A6 | P (0.2) | 8 | 10.6 | 5110 | 98.8 |
| | | | 60 | 219 | 4457 | 97.1 |
| Comp. Ex 2 | C2 | P (0.2) | 8 | 7.2 | 6807 | 98.1 |
| | | | 60 | 202 | 4464 | 96.0 |

*H₂ is measured in a 150-ml vessel and flushed into the 2 L reactor with propylene.

As shown from the above results, the solid catalyst component (Ex. 1-Ex. 4) according to present invention employing Si—N—bond-containing organosilicon compounds in combination with phthalate internal donors (such as diisobutylphthalate) as an element of solid catalyst composition, produce polypropylene with an isotacticity (% HI) much higher than the comparative catalyst components (C1) that does not contain the organosilicon element in its solid catalyst composition. This isotacticity improvement effect is more evident when producing polypropylene with a 200+ MFR. For example, for a given loading of 10.0 mmol of diisobutylphthalate as the internal donor, catalyst component A1-A4 containing organosilicon compounds in its solid catalyst composition produced polypropylene of 97.6˜98.2% HI (Ex. 1˜Ex. 4) with 200+ MFR in the presence of 0.2 mmol P donor and 150 psi H₂, which is much higher than % HI 97.1% with 200+ MFR by comparative catalyst components (C1) that does not contain organosilicon element in its solid catalyst composition.

The same trend has been observed in combination with 1,3-diether internal donors (such as 9,9-bis(methoxymethyl)fluorene). For example, for a given loading of 10.0 mmol of 9,9-bis(methoxymethyl)fluorene as the internal donor, catalyst component A5-A6 containing organosilicon compounds in its solid catalyst composition produced polypropylene of 97.1˜97.9% HI (Ex. 5˜Ex. 6) with 200+ MFR in the presence of 0.2 mmol P donor and 60 psi H₂, which is much higher than % HI 96.0% with 200+ MFR by comparative catalyst components (C2) that does not contain organosilicon element in its solid catalyst composition.

As such, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A solid catalyst component for the polymerization or co-polymerization of alpha-olefins comprising: titanium, magnesium, halogen, one or more internal electron donors, and one or more Si—N—bond-containing organosilicon compounds selected from the compound represented by the formula:
RₘSi(NR¹R²)ₙ(XR³)₍₄₋ₘ₋ₙ₎ [Formula I]
wherein R, R¹, R² and R3, are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hydrocarbon group of 1 to 20 carbon atoms containing one or more hetero-atoms selected from the group consisting of N, O, S, Si, B, P, and halogen atoms;
wherein X is O or S;
wherein m is 0-3, n is 1-4, and m+n is 1-4;
wherein when m>1, R's may be identical or different;
wherein when n>1, R¹'s and R²'s may be identical or different; and
wherein when (4−m−n)>1, (XR³)'s may be identical or different.

2. The component of claim 1, wherein two or more of R, R¹, R² and R³ may be linked to form one or more saturated or unsaturated monocyclic or polycyclic rings.

3. The component of claim 1, wherein the one or more organosilicon compounds are cyclic organosilicon compounds.

4. The component of claim 1, wherein the one or more organosilicon compounds are selected from N,N-diethyl- 1,1 -dimethoxy-1-propylsilanamine, N,N-diethyl-1,1 -diethoxy-1-propylsilanamine, N,N-diethyl-1,1-dimethoxy-1-cyclopentylsilanamine, N-(dimethoxypropylsilyl) -N-ethyl-benzenamine, N-(dimethoxypropylsilyl)-N-ethyl-cyclohexanamine, diethylaminotrimethoxysilane, diethylaminotriethoxysilane, bis(diethylamino)dimethoxysilane, bis(diethylamino)diethoxysilane, di(piperidinyl) dimethoxvsilane, di(piperidinyl)diethoxysilane, di(pyrrolidinyl)dimethoxysilane, di(pyrrolidinyl) diethoxysilane, 2,2′-(dimethoxysilylene)bis(decahydroisoquinoline), and their derivatives.

5. The component of claim 1, wherein at least one of the internal electron donors is selected from 1,3-diether compounds.

6. The component of claim 5, wherein the 1,3-diether compound is selected from 9,9-bis(methoxymethyl)fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,3-benzofluorene; 9,9-bis(methoxymethyl)-2,3,6,7-dibenzofluorene; 9,9-bis(methoxymethyl)-2,7-diisopropylfluorene; 9,9-bis(methoxymethyl)-1, 8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; or 9,9-bis(methoxymethyl)-4-tert-butylfluorene.

7. The component of claim 5, wherein the 1,3-diether compound is selected from 2-(2-ethylhexyl)-1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-diethoxypropane, 2-cumyl-1,3-diethoxypropane, 2-(2-phenylethyl)-1,3-dimethoxypropane, 2-(2-cyclohexylethyl)-1,3-dimethoxypropane, 2-(p-chlorophenyl)1,3-dimethoxypropane, 2-(diphenylmethyl)-1,3-dimethoxypropane, 2-(1-naphthyl)-1,3-dimethoxy propane, 2,2-fluorophenyl)-1,3-dimethoxypropane, 2-(1-decahydronaphthyl)-1,3-dimethoxypropane, 2-(p-t-butylphenyl)-1,3-dimethoxypropane, 2,2-dicyclohexyl-1,3-dimethoxypropane, 2-isopentyl-2-isopropyl-1,3-dimethoxypropane, 2,2-diisobutyl-1,3-dimethoxypropane; 2-isopropyl 2-isopentyl-1,3-dimethoxypropane; or 2,2-bis(cyclohexylmethyl)-1,3-dimethoxypropane.

8. The component of claim 1, wherein at least one of the internal electron donors is selected from esters of phthalic acid.

9. The component of claim 1, wherein at least one of the internal electron donors is selected from malonate compounds.

10. The component of claim 1, wherein at least one of the internal electron donors is selected from esters of succinic acid compounds.

11. The component of claim 1, wherein at least one of the internal electron donors is selected from esters of diol compounds.

12. A catalyst system for the polymerization or co-polymerization of alpha-olefins comprising:
a) a solid catalyst component according to claim 1; and
b) a co-catalyst component comprising an organoaluminum compound represented by the general formula: RₙAlQ₃₋ₙ, wherein R represents an alkyl group having 1 to 6 carbon atoms, Q represents a hydrogen or a halogen atom, and n represents a real number that satisfies 0<n≤3.

13. The catalyst system of claim 12, further comprising: (c) one or more external electron donor components.
